(19) United States
(12) Patent Application Publication
(10) Pub. No.: US 2008/0125549 A1
(43) Pub. Date: May 29, 2008

(54) COUPLING OF LIVING CARBOCATIONIC POLYMERS

(75) Inventors: Judit E. PUSKAS, Akron, OH (US); Szilard Csihony, Weinheim (DE); Konrad Knoll, Mannheim (DE); Heike Pfistner, Ludwigshafen (DE); Hans-Michael Walter, Freinsheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/564,650

(22) Filed: Nov. 29, 2006

(51) Int. Cl. C08F 297/00

(52) U.S. Cl. 525/314

(57) ABSTRACT

A process for coupling a living carbocationic polymer by reacting two molecules of a living carbocationic polymer with a coupling agent, the coupling agent having the formula I:

CR¹R²═CR³-Zₙ—CR⁴═CR⁵R⁶ (I)

wherein R¹, R², R³, R⁴, R⁵ and R⁶ are, independently from one another, hydrogen, alkyl, or alkenyl, or two of R¹, R², R³, R⁴, R⁵ and R⁶, together are alkylene or alkenylene, Z is CR⁷R⁸, R⁷ and R⁸ are, independently from one another, hydrogen or alkyl, and n is 0 or an integer from 1 to 5, with the proviso that, when R³ is hydrogen, both R¹ and R² are different from hydrogen, and, when R⁴ is hydrogen, both R⁵ and R⁶ are different from hydrogen. The process allows for the convenient preparation of ABA-type block copolymers and of telechelic polymers.

The present invention relates to a process for coupling a living carbocationic polymer by reacting two molecules of a living carbocationic polymer with a coupling agent. The invention further relates to a telechelic polymer obtainable by this process.

One attempt at controlling the molecular weight ranges and molecular structure of polymers has made use of living polymerizations. These are polymerizations which proceed without termination and chain transfer. As a consequence, living polymerizations generally yield polymers with a well-defined structure, controlled molecular weight, and narrow molecular weight distribution.

Living anionic polymers are well known in the art but relatively few truly living carbocationic systems have been studied. Living carbocationic polymerization is subject to certain restrictions; the manufacture of ABA triblock copolymers is rarely feasible by means of sequential polymerization, in particular if the “crossover” from monomer B to monomer A proceeds with low efficiency. Coupling of living AB diblock copolymers to yield ABBA triblock copolymers is a viable, alternative synthetic approach.

The coupling of living polymers has been described in the prior art. “Coupling” means chemically linking two polymer molecules together to form a single molecule. Coupling of polymers is a convenient approach for synthesizing specific purpose-tailored polymers. By coupling living polymers that have a functional group at the beginning of their chain, one can produce telechelic polymers, i.e. linear or star-type polymers having functional groups at both or all of their ends.

A description of coupling reactions and coupling agents may be found in the following references: R. Faust, S. Hadjikyriacou, Macromolecules 2000, 33, 730-733; R. Faust, S. Hadjikyriacou, Macromolecules 1999, 32, 6393-6399; R. Faust, S. Hadjikyriacou, Polym. Bull. 1999, 43, 121-128; R. Faust, Y. Bae, Macromolecules 1997, 30, 198; R. Faust, Y. Bae, Macromolecules 1998, 31, 2480; R. Storey, Maggio, Polymer Preprints, 1998, 39, 327-328; WO99/24480; U.S. Pat. No. 5,690,861 and U.S. Pat. No. 5,981,785.

There is a continuing demand for a readily available, non-aromatic, non-heteroatom-containing coupling agent that may be used for the coupling of polymers, irrespective of the molecular weight of the polymer. In particular, the invention seeks to provide a coupling agent that is suitable for the coupling of polymers having a high initial molecular weight.

The invention provides a process for coupling a living carbocationic polymer by reacting two molecules of a living carbocationic polymer with a coupling agent, the coupling agent having the formula I:

CR¹R²═CR³-Zₙ—CR⁴═CR⁵R⁶ (I)

wherein R¹, R², R³, R⁴, R⁵ and R⁶ are, independently from one another, hydrogen, alkyl, or alkenyl, or two of R¹, R², R³, R⁴, R⁵ and R⁶, together are alkylene or alkenylene,

### Z is CR⁷R⁸,

### R⁷ and R⁸ are, independently from one another, hydrogen or alkyl, and

n is 0 or an integer from 1 to 5,
with the proviso that, when R³ is hydrogen, both R¹ and R² are different from hydrogen, and, when R⁴ is hydrogen, both R⁵ and R⁶ are different from hydrogen.

Preferably, R¹, R², R³, R⁴, R⁵ and R⁶ are, independently from one another, hydrogen, C₁-C₄-alkyl, or C₂-C₆-alkenyl, in particular hydrogen or methyl.

If n is 2 or higher, the individual groups Z may be the same or different from one another.

Preferably, R⁷ and R⁸ are, independently from one another, hydrogen or C₁-C₄-alkyl, in particular hydrogen or methyl.

Preferably, n is 0 or 1 or 2.

Two of R¹, R², R³, R⁴, R⁵ and R⁶, together may form an alkylene or alkenylene bridging group, preferably a C₁-C₆-alkylene or C₂-C₆-alkenylene group. Possible bridging groups are, without limitation, as follows (where, e.g., R¹-R² denotes that R¹ and R² together form a bridging group): R¹-R⁶, R¹-R², R¹-R³, R¹-R⁴, R³-R⁴, R¹-R² and R⁵-R⁶, or R¹-R³ and R⁴-R⁶.

Preferred coupling agents according to the invention are the following:
2,3-dimethyl 1,3-butadiene;
2,4-dimethyl 1,3-pentadiene;
2,3-dimethyl 1,3-pentadiene;
2,4-dimethyl 1,4-pentadiene;
2,5-dimethyl 1,5-hexadiene;
7-methyl-3-methyleneocta-1,6-diene (myrcene);
1,5-dimethyl-1,5-cyclooctadiene;
1,6-dimethyl-1,5-cyclooctadiene or mixtures thereof.

The most preferred coupling agent according to the invention is 2,4-dimethyl 1,4-pentadiene.

The coupling agents according to the invention can either be obtained commercially or can be readily synthesized by methods known to a person skilled in synthetic organic chemistry.

A “living carbocationic polymer” as defined herein means a polymer produced by a living cationic polymerization process. The polymer includes a carbocation at an end group of the polymer. This term shall include solvent-separated ions, solvent-separated ion pairs, contact ion pairs and strongly polarized complexes with positive partial charge on one carbon atom at an end group of the polymer, and all intermediate stages thereof.

Suitable living carbocationic polymers have the formula

Ini-A-TG or Ini-A-B-TG or

Ini-B-TG or Ini-B-A-TG

wherein Ini is the residue of a cationic polymerization initiator, A is a polymer block composed of a first ethylenically unsaturated monomer or a first set of ethylenically unsaturated monomers, B is a polymer block composed of a second ethylenically unsaturated monomer or a second set of ethylenically unsaturated monomers, and TG is a terminal group comprising a carbocation or capable of generating a carbocation.

Blockcopolymers with three or even more distinct polymer blocks such as Ini-A-B-C-TG may also be used.

With regard to the properties of the final coupled polymer, polymer blocks A and B preferably show different glass transition temperatures. Preferably, block A will be a soft segment polymer block, whereas block B will be a hard segment polymer block. For example, the soft segment polymer block has a glass transition temperature of 0° C. or less, and the hard segment polymer block has a glass transition temperature of 50° C. or above. Block B may also be composed of a polymer exhibiting a crystalline melting point such as syndiotactic polystyrene.

Typically, polymer block A may be composed of monomers, the majority of which, e.g. more than 60% by weight or more than 80% by weight, are isobutene monomers. The remainder may be monomers that are copolymerizable with isobutene. Polymer block B is typically composed of monomers, the majority of which, e.g. more than 60% by weight or more than 80% by weight, are different from isobutene and, in particular, are styrenic monomers such as styrene, or styrene substituted by 1 or 2 C₁-C₄-alkyl groups, e.g. α-methyl styrene.

Endgroup-functionalized polymers, in particular telechelic polymers, can be produced by living polymerization, and a functionalized initiator can be used to introduce the reactive groups of interest. In preferred embodiments, the residue of a cationic polymerization initiator therefore comprises a functional group, for example a functional group selected from an ethylenically unsaturated group, a silyl-functional group, or an oxygen-containing functional group such as an epoxy group.

Preferably, the living carbocationic polymer has a terminal group or is capable of generating a terminal group selected from

—CH₂—C(CH₃)₂^{⊕},

—CH₂—CHAr^{⊕} or —CH₂—C(CH₃)Ar^{⊕}

wherein Ar is Aryl, for example phenyl or phenyl substituted by 1 or 2 C₁-C₄-alkyl groups.

The coupling reaction is usually carried out in a solvent. Suitable solvents are all low molecular weight, organic compounds or mixtures thereof which have a suitable dielectric constant and no protons that can be abstracted and which are liquid under the polymerization conditions. Preferred solvents are hydrocarbons, e.g. acyclic hydrocarbons having from 2 to 8, preferably from 3 to 8, carbon atoms, e.g. ethane, isopropane and n-propane, n-butane and its isomers, n-pentane and its isomers, n-hexane and its isomers and also n-heptane and its isomers, and n-octane and its isomers, cyclic alkanes having from 5 to 8 carbon atoms, e.g. cyclopentane, methylcyclopentane, cyclohexane, methylcyclohexane, cycloheptane, acyclic alkenes preferably having from 2 to 8 carbon atoms, e.g. ethene, isopropene and n-propene, n-butene, n-pentene, n-hexene and n-heptene, cyclic olefins such as cyclopentene, cyclohexene and cycloheptene, aromatic hydrocarbons such as toluene, xylene, ethylbenzene, and also halogenated hydrocarbons such as halogenated aliphatic hydrocarbons, e.g. chloromethane, dichloromethane, trichloromethane, chloroethane, 1,2-dichloroethane and 1,1,1-trichloroethane and 1-chlorobutane, and halogenated aromatic hydrocarbons such as chlorobenzene and fluorobenzene.

The coupling reaction is usually carried out at a temperature of from −100 to 0° C., e.g. −80 to 0° C., preferably −76 to −64° C.

The coupling reaction may occur in the presence of a suitable Lewis acid, including those which can also be employed for carrying out a living polymerization reaction. In addition, the coupling reaction can be carried out using solvents and temperatures similar to those used for carrying out the actual polymerization reaction. The coupling reaction can therefore advantageously be carried out as a one-pot reaction subsequent to the polymerization reaction in the same solvent in the presence of the Lewis acid used for the polymerization. Alternatively, the polymerization reaction and the coupling reaction may be carried out as a two-step process with the living carbocationic polymer being isolated in between steps.

The molar ratio of the coupling agent to the living carbocationic polymer is sufficient to cause the coupling of the living carbocationic polymer. In a typical embodiment, the molar ratio of the coupling agent to the living carbocationic polymer is in the range of about 1:1 to 1:50, in particular 1:2 to 1:50. Preferably the molar ratio of the coupling agent to the living carbocationic polymer is about 1:2.

After the coupling reaction, the reaction is generally quenched, e.g. by addition of a small amount of water or methanol, and the solvent is removed with a suitable apparatus such as a rotary, falling film or thin film evaporators or by depressurization of the reaction solution.

Preferably, the living carbocationic polymer is selected from polyisobutene, polystyrene, polyalkylstyrene (e.g., polyalpha-methylstyrene, poly-t-butylstyrene), random copolymers or terpolymers of isobutene, styrene and alkylstyrene, block copolymers of isobutene and one or more styrenic monomers, preferably styrene and alpha-methylstyrene. The invention is now described in further detail with respect to isobutene polymers or isobutene copolymers, but is in no way limited thereto.

The preparation of isobutene polymers by living cationic polymerization of isobutene (or of isobutene block copolymers by sequential polymerization of isobutene and monomers other than isobutene) is known. The initiator system generally used comprises a Lewis acid and an organic compound that is capable of forming a carbocation or a cationogenic complex with the Lewis acid.

The initiator is an organic compound which has at least one functional group that can form a carbocation or a cationogenic complex with the Lewis acid under polymerization conditions. The terms “carbocation” and “cationogenic complex” are not strictly separated from one another, but rather include all intermediate stages of solvent-separated ions, solvent-separated ion pairs, contact ion pairs and strongly polarized complexes with positive partial charge on one carbon atom of the initiator molecule.

Suitable initiators include organic compounds which have at least one leaving group X and which can stabilize a positive charge or partial charge on the carbon atom that bears the leaving group X. As is well known, these include compounds which have at least one leaving group X that is bonded to a primary, or, preferably, secondary or tertiary aliphatic carbon atom, or to an allylic or benzylic carbon atom. Useful leaving groups are halogen, alkoxy, preferably C₁-C₆-alkoxy, and acyloxy (alkylcarbonyloxy), preferably C₁-C₆-alkylcarbonyloxy.

Halogen is in particular chlorine, bromine or iodine and especially chlorine. C₁-C₆-Alkoxy may be either linear or branched, and is, for example, methoxy, ethoxy, n-propoxy, isopropoxy, n-butoxy, isobutoxy, n-pentoxy and n-hexoxy, in particular methoxy. C₁-C₆-Alkylcarbonyloxy is, for example, acetoxy, propionyloxy, n-butyroxy and isobutyroxy, in particular acetoxy.

Typically the initiator has at least one functional group of the general formula

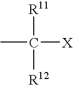

in which
X is selected from halogen, C₁-C₆-alkoxy and C₁-C₆-acyloxy,
R¹¹ is hydrogen or methyl and
R¹² is methyl or, with R¹¹ or the molecular moiety to which the functional group is bonded, forms a C₅-C₆-cycloalkyl ring; R¹² may also be hydrogen when the functional group is bonded to an aromatic or olefinically unsaturated carbon atom.

The initiator used may be monofunctional or polyfunctional, in particular bifunctional. Polymers that have been produced from bifunctional initiators can be coupled to yield multiblock copolymers, as exemplified by the following equitation (wherein CA denotes the coupling agent):

nTG-B-A-Ini-A-B-TG+nCA→-[-TG-B-A-Ini-A-B-TG-CA-]ₙ-

Preferred initiators are the following (in which X is as defined above):

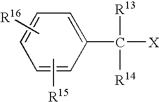

where R¹³, R¹⁴ are each independently hydrogen or methyl; R¹⁵, R¹⁶ are each independently hydrogen, C₁-C₄-alkyl, or a silyl functional group such as 2-(dichloromethylsilyl)-ethyl or 1-(dichloromethylsilylmethyl)-ethyl. Examples of this type of initiator include 2-chloro-2-phenylpropane, 4-(2-dichloromethylsilyl-ethyl)benzyl chloride or 2-chloro-2-(3-((1-dichloromethylsilylmethyl)-ethyl)-phenyl)-propane.

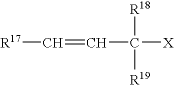

where R¹⁷ is hydrogen, or C₁-C₄-alkyl; R¹⁸, R¹⁹ are each independently hydrogen or methyl. Examples of this type of initiator include allyl chloride, methallyl chloride, 2-chloro-2-methylbutene-2 and 2,5-dichloro-2,5-dimethylhexene-3.

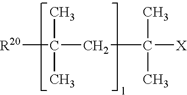

where R²⁰ is hydrogen or methyl and I is 0 or an integer from 1 to 5.

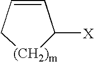

where m is 1, 2 or 3, as described in WO 03/074577. Examples of this type of initiator include 3-chlorocyclopentene.

Another useful class of initiators is organic epoxide compounds, in particular substituted epoxides, as described in U.S. Pat. No. 6,268,446 and U.S. Pat. No. 6,495,647. The epoxide initiator yields polymers carrying oxygen containing functional groups. Examples of this type of initiator include 2,4,4-trimethyl-pentyl-epoxide or α-methylstyrene epoxide.

Useful bifunctional initiators are selected from 1,4-dichloro-1,4-dimethylcyclooctane, 1,5-dichloro-1,5-dimethylcyclooctane and mixtures thereof. These initiators are obtainable by hydrochlorination of 1,5-dimethylcycloocta-1,5-diene or 1,6-dimethylcycloocta-1,5-diene or a mixture thereof. The formula of 1,5-dichloro-1,5-dimethylcyclooctane is depicted below.

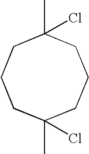

Useful Lewis acids are covalent metal halides and semimetal halides which have a vacant orbital for an electron pair. Such compounds are known to those skilled in the art, for example from J. P. Kennedy et al. in U.S. Pat. No. 4,946,889, U.S. Pat. No. 4,327,201, U.S. Pat. No. 5,169,914, EP-A-206 756, EP-A-265 053 and, comprehensively, in J. P. Kennedy, B. Ivan, “Designed Polymers by Carbocationic Macromolecular Engineering”, Oxford University Press, New York, 1991. They are generally selected from halogen compounds of titanium, of tin, of aluminum, of vanadium, or of iron, and the halides of boron. Preference is given to the chlorides and, in the case of aluminum, also to the monoalkylaluminum dichlorides and the dialkylaluminum chlorides. Preferred Lewis acids are titanium tetrachloride, boron trichloride, boron trifluoride, tin tetrachloride, aluminum trichloride, vanadium pentachloride, iron trichloride, alkylaluminum dichlorides and dialkylaluminum chlorides. Particularly preferred Lewis acids are titanium tetrachloride, boron trichloride and ethylaluminum dichloride and in particular titanium tetrachloride. Alternatively, a mixture of at least two Lewis acids may also be used, for example boron trichloride in a mixture with titanium tetrachloride.

It has been found useful to carry out the polymerization in the presence of an electron pair donor. Useful electron pair donors include aprotic organic compounds which have a free electron pair on a nitrogen, oxygen or sulfur atom. Preferred donor compounds are selected from pyridines such as pyridine, 2,6-dimethylpyridine, alpha-picoline, and sterically hindered pyridines such as 2,6-diisopropylpyridine and 2,6-di-tert-butyl-pyridine; amides, in particular N,N-dialkylamides of aliphatic or aromatic carboxylic acids, such as N,N-dimethylacetamide; lactams, in particular N-alkyllactams such as N-methylpyrrolidone; ethers, e.g. dialkyl ethers such as diethyl ether and diisopropyl ether, cyclic ethers such as tetrahydrofuran; amines, in particular trialkylamines such as triethylamine; esters, in particular C₁-C₄-alkyl esters of aliphatic C₁-C₆-carboxylic acids; thioethers, in particular dialkyl thioethers or alkyl aryl thioethers such as methyl phenyl sulfide; sulfoxides, in particular dialkyl sulfoxides such as dimethyl sulfoxide; nitriles, in particular alkylnitriles such as acetonitrile and propionitrile; phosphines, in particular trialkylphosphines or triarylphosphines, such as trimethylphosphine, triethylphosphine, tri-n-butyl phosphine and triphenylphosphine, and nonpolymerizable, aprotic organosilicon compounds which have at least one organic radical bonded via oxygen.

Another preferred class of electron pair donor compounds is nonpolymerizable, aprotic organosilicon compounds which have at least one organic radical bonded via oxygen.

The organosilicon compounds may have one or more, for example 2 or 3, silicon atoms having at least one organic radical bonded via oxygen. Preference is given to those organosilicon compounds which have one, two or three, and in particular two or three, organic radicals bonded via oxygen per silicon atom.

Particularly preferred organosilicon compounds of this type are those of the following general formula:

R^{a}ᵣSi(OR^{b})₄₋ᵣ

where r is 1, 2 or 3,

### R^{a} may be the same or different and are each independently C₁-C₂₀-alkyl, C₃-C₇-cycloalkyl, aryl or aryl-C₁-C₄-alkyl, while the latter three radicals may also have one or more C₁-C₁₀-alkyl groups as substituents, and

### R^{b} are the same or different and are each C₁-C₂₀-alkyl or, in the case that r is 1 or 2, two R^{b} radicals together may be alkylene.

In the above formula, r is preferably 1 or 2. R^{a} is preferably a C₁-C₈-alkyl group and is in particular an alkyl group that is branched or bonded via a secondary carbon atom, such as isopropyl, isobutyl, sec-butyl, or a 5-, 6- or 7-membered cycloalkyl group, or an aryl group, in particular phenyl. The variable R^{b} is preferably a C₁-C₄-alkyl group or is a phenyl, tolyl or benzyl radical.

Examples of preferred compounds of this type are dimethoxydiisopropylsilane, dimethoxyisobutylisopropylsilane, dimethoxydiisobutylsilane, dimethoxydicyclopentylsilane, dimethoxyisobutyl-2-butylsilane, diethoxyisobutylisopropylsilane, triethoxytolylsilane, triethoxybenzylsilane and triethoxyphenylsilane.

The Lewis acid is used in an amount which is sufficient to form the initiator complex. The molar ratio of Lewis acid to initiator is generally from 30:1 to 1:10, preferably 10:1 to 1:10, in particular from 5:1 to 1:2.

Isobutene feedstocks which are suitable for use in the process of the present invention include both isobutene itself and isobutene C₄-hydrocarbon streams, for example C₄ raffinates, C₄ fractions from isobutene dehydrogenation, C₄ fractions from steam crackers and FCC plants (FCC: fluid catalytic cracking), as long as they have been largely freed of 1,3-butadiene. C₄-hydrocarbon streams which are suitable for the purposes of the present invention generally contain less than 500 ppm, preferably less than 200 ppm, of butadiene.

The reaction can also be carried out using monomer mixtures of isobutene with olefinically unsaturated monomers which are copolymerizable with isobutene under cationic polymerization conditions. Furthermore, the process of the present invention is suitable for the block copolymerization of isobutene with ethylenically unsaturated comonomers which are polymerizable under cationic polymerization conditions. If monomer mixtures of isobutene with suitable comonomers are to be polymerized, the monomer mixture preferably comprises more than 80% by weight, in particular more than 90% by weight and particularly preferably more than 95% by weight, of isobutene and less than 20% by weight, preferably less than 10% by weight, and in particular less than 5% by weight, of comonomers.

Possible copolymerizable monomers are vinylaromatics such as styrene and α-methylstyrene, C₁-C₄-alkylstyrenes such as 2-, 3- and 4-methylstyrene, and also 4-tert-butylstyrene, isoolefins having from 5 to 10 carbon atoms, e.g. 2-methyl-1-butene, 2-methyl-1-pentene, 2-methyl-1-hexene, 2-ethyl-1-pentene, 2-ethyl-1-hexene and 2-propyl-1-heptene.

The polymerization is usually carried out in a solvent. Possible solvents are all low molecular weight, organic compounds or mixtures thereof which have a suitable dielectric constant and no protons that can be abstracted and which are liquid under the polymerization conditions. Preferred solvents are hydrocarbons, e.g. acyclic hydrocarbons having from 2 to 8, preferably from 3 to 8, carbon atoms, e.g. ethane, isopropane and n-propane, n-butane and its isomers, n-pentane and its isomers, n-hexane and its isomers and also n-heptane and its isomers, and n-octane and its isomers, cyclic alkanes having from 5 to 8 carbon atoms, e.g. cyclopentane, methylcyclopentane, cyclohexane, methylcyclohexane, cycloheptane, acyclic alkenes preferably having from 2 to 8 carbon atoms, e.g. ethene, isopropene and n-propene, n-butene, n-pentene, n-hexene and n-heptene, cyclic olefins such as cyclopentene, cyclohexene and cycloheptene, aromatic hydrocarbons such as toluene, xylene, ethylbenzene, and also halogenated hydrocarbons such as halogenated aliphatic hydrocarbons, e.g. chloromethane, dichloromethane, trichloromethane, chloroethane, 1,2-dichloroethane and 1,1,1-trichloroethane and 1-chlorobutane, and halogenated aromatic hydrocarbons such as chlorobenzene and fluorobenzene. The halogenated hydrocarbons used as solvents do not include any compounds in which halogen atoms are located on secondary or tertiary carbon atoms.

Particularly preferred solvents are aromatic hydrocarbons, among which toluene is particularly preferred. Preference is likewise given to solvent mixtures which comprise at least one halogenated hydrocarbon and at least one aliphatic or aromatic hydrocarbon. In particular, the solvent mixture comprises hexane and chloromethane and/or dichloromethane. The volume ratio of hydrocarbon to halogenated hydrocarbon is preferably in the range of 1:10 to 10:1, particularly preferably in the range of 4:1 to 1:4, and in particular in the range of 2:1 to 1:2.

The polymerization is generally carried out at a temperature below 0° C., e.g. in the range of 0 to −140° C., preferably in the range of −30 to −120° C., and particularly preferably in the range of −40 to −110° C. The reaction pressure is not of critical importance.

The reaction heat is removed in a customary manner, for example by wall cooling and/or evaporative cooling. Here, the use of ethene and/or mixtures of ethene with the solvents mentioned above as preferred has proven useful.

The accompanying figures and the following examples illustrate the invention.

In the drawings,

FIG. 1 shows the overlaid SEC traces of the starting and coupled polyisobutene (PIB) with 2,4-dimethyl-1,4-pentadiene/PIB ratio of 0.5.

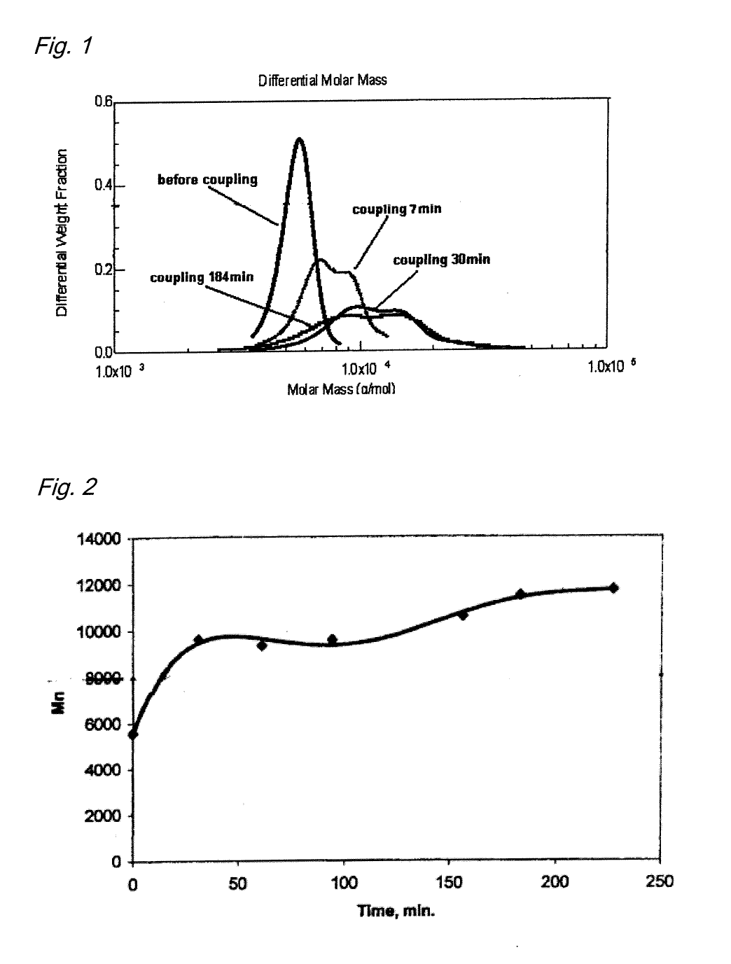

FIG. 2 shows the molecular weight Mn versus time for coupling reactions with 2,4-dimethyl-1,4-pentadiene/PIB ratio of 1.0.

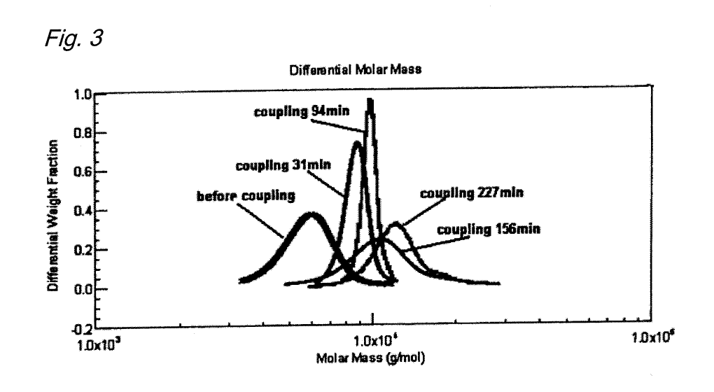

FIG. 3 shows the overlaid SEC traces of the starting and coupled polyisobutene (PIB) with 2,4-dimethyl-1,4-pentadiene/PIB ratio of 1.0.

### EXAMPLE 1

### Coupling of Living PIB Polymers Using 2,4-dimethyl-1,4-pentadiene

α-Methylstyrene epoxide (MSE) was synthesized as described by Song, J. S.; Bódis, J.; Puskas, J. E. J. Polym. Sci. Part A: Polym. Chem. 2002, 40, 1005-15, 2,4-dimethyl-1,4-pentadiene (DMP) (Chemsampco, Inc., 39% nominal purity) was used as received. Isobutylen (IB) and methyl chloride (MeCl, BOC) were dried by being passed through a column filled with BaO and CaCl₂. Hexane (Caledon) was distilled from CaH₂ before use. Titanium tetrachloride (TiCl₄), di-tert-butylpyridine (DtBP), 2-phenyl-1-propanol (PPOH, Aldrich, 97%), carbon tetrachloride (CCl₄, Aldrich, anhydrous) were used as received.

### Polymerization

The polymerization reactions were carried out in an Mbraun LabMaster 130 glove box equipped with an integral cold bath (hexane) chilled with an FTS Flexi Cool immersion cooler. The moisture (<1 ppm) and oxygen (<5 ppm) contents were monitored. A 500 ml round-bottom flask equipped with overhead stirrer was charged with CH₃Cl/hexane (40/60 v/v). DtBP (0.007 mol) was introduced to the mixture, and then MSE (0.019 mole) and IB (2.1 mole) were added. The reactants were stirred for approximately 30 minutes. Previously, a 1 mol/L TICl₄ stock solution was prepared and prechilled to the reaction temperature (−60° C.). The polymerization commenced with the rapid introduction of TiCl₄ stock solution (0.064 mol). The reactions were terminated at specified times by the addition of methanol to the charges. The solvents were evaporated, and the polymers were purified by being redissolved in hexane, washed with distilled water, dried over MgSO₄, filtered and precipitated from methanol, and dried in a vacuum oven. The final conversion was determined gravimetrically. ¹H-NMR and ¹³C-NMR spectra demonstrate that PIBs synthesized by living polymerization initiated with the MSE/TiCl₄ initiating system carry one primary hydroxyl functionality per molecule. The number-averaged molecular weight Mn and the molecular weight distribution (MWD=Mw/Mn) of the polymers are shown in table 1.

TABLE 1
PIBs synthesized with the MSE/TiCl₄ initiating system

| | Polymerization | Polymerization | | |
|---|---|---|---|---|
| Sample # | temperature (° C.) | time (min) | Mn (g/mol) | MWD |
| 1 | −60 | 11.0 | 4300 | 1.07 |
| 2 | −60 | 11.4 | 4600 | 1.01 |
| 3 | −60 | 11.5 | 5000 | 1.03 |
| 4 | −60 | 15.0 | 5600 | 1.06 |
| 5 | −60 | 10.0 | 4900 | 1.11 |

### Coupling Reaction

A 500 ml round-bottom flask equipped with overhead stirrer was charged with CH₃Cl/hexane (40/60 v/v). PIBs carrying primary hydroxyl head and the tertiary chloride end groups, synthesized as described above, were dissolved in CH₃Cl/hexane (40/60 v/v). Then DtBP and TiCl₄ were added. Coupling was effected by introducing DMP.

The coupling reaction of living PIB by DMP was carried out using [DMP]/[living PIB]=0.5 mol/mol and 0.1 mol/mol, respectively. At predetermined times, samples were withdrawn, quenched with prechilled methanol, and analyzed by size exclusion chromatography (SEC) to monitor the progress of the coupling reaction. Coupling efficiency was calculated as follows:

Coupling efficiency=(Mn of coupled PIB)/(2*Mn of PIB before coupling)

SEC data are listed in tables 2 and 3.

With a [DMP]/[living PIB] ratio of 0.5 mol/mol, after 7 minutes the coupling efficiencies were in excess of 100%. SEC traces (FIG. 1) show bimodal distribution. The peak molecular weight of the first peak is approximately double that of the starting monofunctional PIB, while the peak molecular weight of the second peak is approximately three times that of the starting material. Presumably, along with the coupled product, three-arm star PIBs were also produced.

With a [DMP]/[living PIB] ratio of 1.0 mol/mol, the molecular weight nearly doubled in 30 minutes and remained constant for about two hours (FIG. 2), and then increased further to produce 100% coupling efficiency. The SEC traces (FIG. 3) show the narrow molecular weight distributions of the coupled PIBs.

TABLE 2
Coupling reaction of living PIB in the presence of TiCl₄ in
hexane/CH₃Cl 60/40 (v/v) at −80° C., [DMP]/[living PIB] =
0.5 mol/mol

| | | | | Coupling |
|---|---|---|---|---|
| Coupling time | | | | efficiency (%) |
| (min) | Mn | Mw | MWD | by SEC |
| 0 | 5000 | 5100 | 1.03 | — |
| 7 | 12000 | 14500 | 1.21 | 120 |
| 16 | 11600 | 14700 | 1.27 | 116 |
| 30 | 13400 | 16200 | 1.21 | 134 |
| 61 | 12000 | 15500 | 1.29 | 120 |
| 91 | 8500 | 9900 | 1.17 | 85 |
| 123 | 12100 | 13400 | 1.10 | 121 |
| 157 | 11600 | 12600 | 1.17 | 116 |
| 184 | 11400 | 15800 | 1.39 | 114 |

TABLE 3
Coupling reaction of living PIB in the presence of TiCl4 in
hexane/CH3Cl 60/40 (v/v) at −80° C., [DMP]/[living PIB] =
1.0 mol/mol

| | | | | Coupling |
|---|---|---|---|---|
| Coupling time | | | | efficiency (%) |
| (min) | Mn | Mw | MWD | by SEC |
| 0 | 5600 | 5900 | 1.06 | — |
| 31 | 9600 | 9900 | 1.02 | 86 |
| 61 | 9400 | 9700 | 1.04 | 84 |
| 94 | 9600 | 9600 | 1.00 | 86 |
| 156 | 10600 | 11400 | 1.07 | 95 |
| 183 | 11500 | 11600 | 1.01 | 103 |
| 227 | 11700 | 12400 | 1.06 | 105 |

The envisioned coupling reaction of living PIB with DMP is shown below:

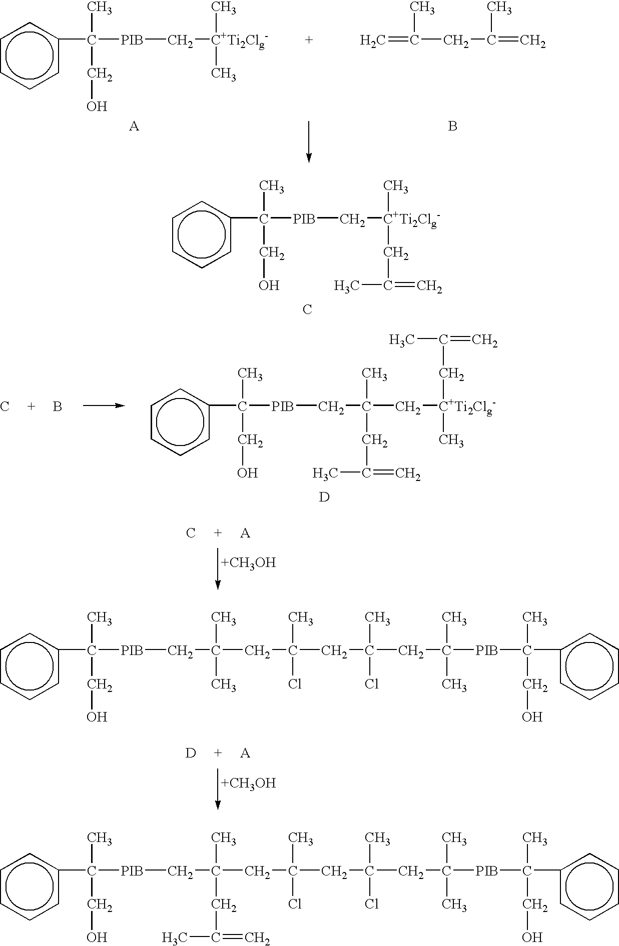

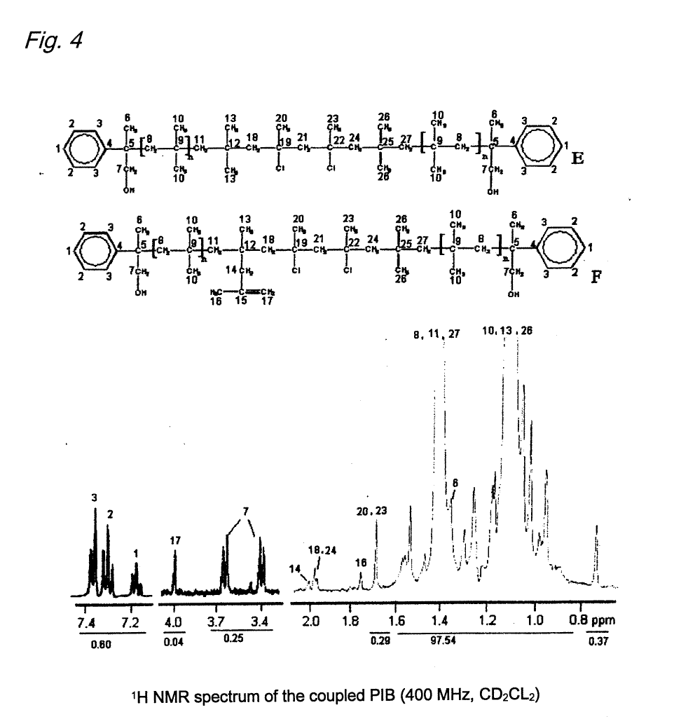

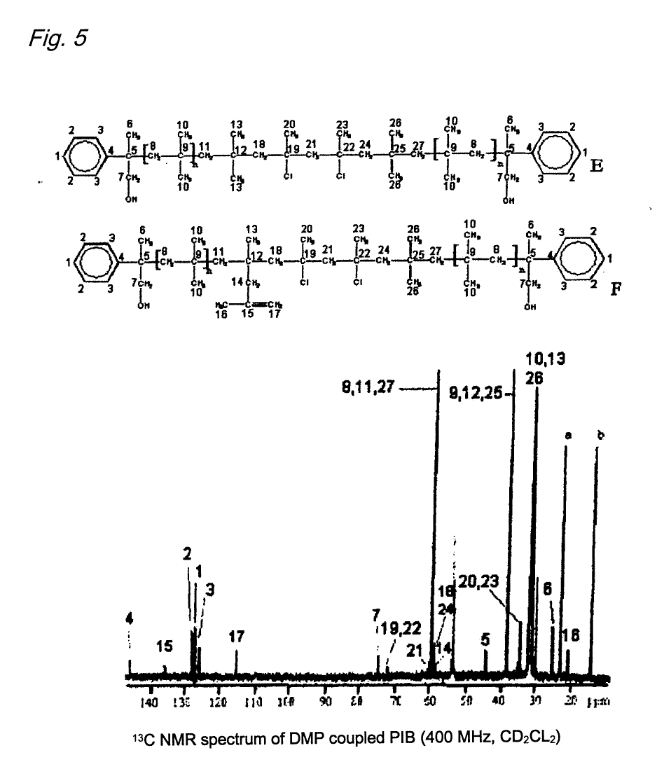

A representative coupled PIB (Table 3, after 227 min coupling time) was characterized by ¹H NMR and ¹³C NMR spectroscopy. The ¹H NMR and ¹³C NMR spectra (400 MHz, CD₂Cl₂) are shown in FIG. 4 and FIG. 5, respectively, together with a presumptive allocation of the NMR signals.

### EXAMPLE 2

### Coupling of Living PIB Polymers Using 2,5-dimethyl-1,5-hexadiene

200 ml (2 mol) isobutene was dissolved in a mixture of 150 mL dried hexane 150 mL dichloromethane and cooled to −76° C. First, 17.13 g (65 mmol) hexadecenyl chloride was added to the solution via a syringe. Then, a mixture of 1.7 g (7 mmol) triethoxyphenylsilane and 8.5 g (45 mmol) TiCl₄ was added via a syringe. The reaction mixture was stirred 2 hours at −76° C. The temperature rose from −76° C. to −32° C. and the color of the reaction mixture changed from clear to slightly yellow. The reaction was split in two equal parts. One part was quenched by addition of 5 ml ethanol. The mixture was diluted with 75 ml hexane, extracted with water (3×75 mL) and dried over sodium sulphate. The solvents were removed at 5 mbar/50° C. Yield: 63.0 g. Mn (GPC): 2186; MWD: 1.18.

2.25 g (20 mmol) 2,5-dimethyl-1,5-hexadiene was added to the other part and the mixture was stirred one hour at −76° C. The reaction was quenched by addition of 5 ml ethanol. The mixture was diluted with 75 ml hexane, extracted with water (3×75 mL) and dried over sodium sulphate. The solvents were removed at 5 mbar/50° C. Yield: 49.1 g. Mn (GPC): 2614; MWD: 1.29.

The coupling efficiency was about 40%. The PIB/coupling agent molar ratio used was about 32:20 mmol.

The above operations were repeated using different PIB/coupling agent ratios in the coupling reaction. The results are given in Table 4.

TABLE 4
PIB Coupling using 2,5-dimethyl-1,5-hexadiene coupling agent with different
PIB/coupling agent ratios

| Mn before | | PIB/coupling | Mn after 3 h | MWD after | |
|---|---|---|---|---|---|
| coupling | MWD before | agent ratio | coupling | 3 h coupling | Coupling efficency |
| (g/mol) | coupling | (mmol:mmol) | time (g/mol) | time | (%) |
| 2096 | 1.14 | 32:40 | 2488 | 1.23 | 35 |
| 2689 | 1.15 | 32:80 | 2766 | 1.25 | n.d. |
| 2528 | 1.15 | 32:10 | 2769 | 1.21 | 25 |
| 2404 | 1.15 | 32:5 | 2503 | 1.23 | 20 |

### EXAMPLE 3

### Coupling of Living PIB Polymers Using 7-methyl-3-methyleneocta-1,6-diene

200 ml (2 mol) isobutene was dissolved in a mixture of 150 mL dried hexane 150 mL dichloromethane and cooled to −76° C. First, 17.13 g (65 mmol) hexadecenyl chloride was added to the solution via a syringe. Then, a mixture of 1.7 g (7 mmol) triethoxyphenylsilane and 8.5 g (45 mmol) TiCl₄ was added via a syringe. The reaction mixture was stirred 2 hours at −76° C. The temperature rose from −76° C. to −32° C. and the color of the reaction mixture changed from clear to slightly yellow. The reaction was split into two equal parts. One part was quenched by addition of 500 ml methanol. The polymer was collected and dried at 5 mbar/50° C. Yield: 53.3 g. Mn (GPC): 2821; MWD: 1.16.

3.2 g (20 mmol) 7-methyl-3-methyleneocta-1,6-diene (myrcene) was added to the other part and the mixture was stirred at −76° C. for 3 hours. The temperature of the reaction mixture rose from −76° C. to −66° C. The reaction was quenched by addition of 500 ml methanol. The polymer was collected and dried at 5 mbar/50° C. Yield: 66.5 g. Mn (GPC): 3726; MWD: 3.25.

We claim:

1. A process for coupling a living carbocationic polymer by reacting two molecules of a living carbocationic polymer with a coupling agent, the coupling agent having the formula I:
CR¹R²═CR³-Zₙ—CR⁴═CR⁵R⁶ (I)
wherein R¹, R², R³, R⁴, R⁵ and R⁶ are, independently from one another, hydrogen, alkyl, or alkenyl, or two of R¹, R², R³, R⁴, R⁵ and R⁶, together are alkylene or alkenylene,
Z is CR⁷R⁸,
R⁷ and R⁸ are, independently from one another, hydrogen or alkyl, and
n is 0 or an integer from 1 to 5,
with the proviso that, when R³ is hydrogen, both R¹ and R² are different from hydrogen, and, when R⁴ is hydrogen, both R⁵ and R⁶ are different from hydrogen.

2. The process of claim 1, wherein the living carbocationic polymer has the formula
Ini-A-TG or Ini-A-B-TG or
Ini-B-TG or Ini-B-A-TG
wherein Ini is the residue of a cationic polymerization initiator, A is a polymer block composed of a first ethylenically unsaturated monomer or a first set of ethylenically unsaturated monomers, B is a polymer block composed of a second ethylenically unsaturated monomer or a second set of ethylenically unsaturated monomers, and TG is a terminal group comprising a carbocation or capable of generating a carbocation.

3. The process of claim 2, wherein the living carbocationic polymer has a terminal group or is capable of generating a terminal group selected from
—CH₂—C(CH₃)₂^{⊕},
—CH₂—CHAr^{⊕} or —CH₂—C(CH₃)Ar^{⊕}
wherein Ar is Aryl.

4. The process of claim 2, wherein the residue of a cationic polymerization initiator comprises a functional group selected from an ethylenically unsaturated group, a silyl-functional group, or an epoxy group.

5. The process of any one of claims 2 to 4, wherein polymer block A comprises at least 80% by weight of isobutene repeating units, and polymer block B comprises at least 80% by weight of monomers selected from styrene and α-methyl styrene.

6. The process of any one of the preceding claims, wherein the coupling agent is selected from the group consisting of
2,3-dimethyl 1,3-butadiene;
2,4-dimethyl 1,3-pentadiene;
2,3-dimethyl 1,3-pentadiene;
2,4-dimethyl 1,4-pentadiene;
2,5-dimethyl 1,5-hexadiene;
7-methyl-3-methyleneocta-1,6-diene;
1,5-dimethyl-1,5-cyclooctadiene;
1,6-dimethyl-1,5-cyclooctadiene or mixtures thereof.

7. The process of any one of the preceding claims, wherein the coupling reaction is conducted in the presence of a Lewis acid.

8. The process of any one of the preceding claims, wherein the coupling reaction is conducted at a temperature of from −76 to −64° C.

9. A telechelic polymer obtainable by a process according to any one of the preceding claims.
